(19) United States
(12) Patent Application Publication
(10) Pub. No.: US 2026/0307805 A1
(43) Pub. Date: Oct. 8, 2026

(54) Monument Tray Table Release

(71) Applicant: B/E Aerospace, Inc., Winston Salem, NC (US)

(72) Inventors: Kyle Nathen Swen, Crystal Lake, IL (US); Travis John Vaninetti, Bothell, WA (US); Travis K. Finlay, Durham, NC (US); Christopher D. Adcock, Advance, NC (US)

(73) Assignee: B/E Aerospace, Inc., Winston Salem, NC (US)

(21) Appl. No.: 19/636,730

(22) Filed: Apr. 1, 2026

Related U.S. Application Data
(60) Provisional application No. 63/783,617, filed on Apr. 4, 2025.

(51) Int. Cl. B64D 11/06

(52) U.S. Cl. CPC B64D 11/0638

(57) ABSTRACT

An aircraft monument may comprise a latch for retaining a tray table in a stowed position. The latch may be rotatable from a retention position to a released position, in which the tray table is free to extend from the aircraft monument. The latch may comprise an upper portion and a lower portion disposed on opposing sides of a pivot point. The upper portion may define a rounded upper profile having a finger pull channel for ergonomically rotating the latch. The latch may be biased toward the retention position. In response to the tray table being in the extended position, the latch may be biased toward an unengaged position. In the unengaged position, the latch may be configured to passively actuate from the unengaged position to the retention position in response to rotation of the tray table into the aircraft monument.

### CROSS REFERENCE TO RELATED APPLICATIONS

This application claims the benefit and priority of U.S. Provisional Application No. 63/783,617, entitled “MONUMENT TRAY TABLE RELEASE,” filed on Apr. 4, 2025, which is hereby incorporated by reference in its entirety for all purposes.

### TECHNICAL FIELD

The present disclosure relates generally to a tray table latch and, more particularly, to a latch for retaining and/or releasing a rotatable tray table within/from an aircraft monument.

### BACKGROUND

Aircraft wheelchair plinths are typically disposed facing open spaces, such as an aisle, and are typically not aft of a seat or a wall. Latches for retaining tray tables against seat backs or walls may not be compatible with retaining trays discretely within structures such as aircraft monuments. Latches disposed on outer walls of aircraft monuments may obstruct other structures on the aircraft monument or be accessible to unauthorized users.

### SUMMARY

In one aspect, a latch system is disclosed. In various embodiments, the latch system comprises a pivot point, an upper portion disposed on a first side of the pivot point and defining an upper profile, a lower portion disposed on an opposing side of the pivot point, and a finger pull channel extending into the upper profile for ergonomic application of a rotational force to the upper portion.

In various embodiments, the latch system may further comprise a stop configured to engage the upper portion and to prevent over rotation of the latch system.

In various embodiments, the latch system may further comprise a spring configured to bias the upper portion toward the stop.

In various embodiments, the lower portion may define a lower profile having rounded edges.

In various embodiments, the lower portion may be substantially cuboid.

In various embodiments, when in a retention position the lower portion may be in a vertical position and the latch system may be configured to rotate from the retention position to a released position in response to the rotational force being applied to the finger pull channel.

In another aspect, an aircraft monument is disclosed. In various embodiments, the aircraft monument comprises a vertical pocket and a latch disposed within the vertical pocket. The latch may comprise a pivot point, an upper portion disposed on a first side of the pivot point and defining an upper profile, a lower portion disposed on an opposing side of the pivot point, and a finger pull channel extending into the upper profile for ergonomic application of a rotational force to the upper portion.

In various embodiments, the aircraft monument may further comprise a pivot mount disposed within the vertical pocket and a tray table configured to be disposed within the vertical pocket in a stowed position and rotate from the vertical pocket about the pivot mount to an extended position. In various embodiments, the latch may be configured to retain the tray table when in the stowed position.

In various embodiments, in response to being in a retention position, the latch may be configured to retain the tray table in the stowed position.

In various embodiments, the latch may be biased toward the retention position.

In various embodiments, the latch may further comprise a stop configured to engage the upper portion and to prevent over rotation of the latch.

In various embodiments, the latch may be configured to rotate from the retention position to a released position in response to application of the rotational force to the latch.

In various embodiments, in response to the tray table being rotated to the extended position, the latch may be biased toward an unengaged position.

In various embodiments, in the unengaged position, the latch is fully contained within the vertical pocket.

In various embodiments, in the unengaged position, the latch may be configured to actuate from the unengaged position to the retention position in response to rotation of the tray table into the vertical pocket.

In another aspect, an aircraft is disclosed. In various embodiments, the aircraft may comprise a wheelchair plinth, an aircraft monument disposed proximate the wheelchair plinth, a tray table rotatable from a stowed position within the aircraft monument toward the wheelchair plinth to an extended position, and a latch configured to retain the tray table within the aircraft monument.

In various embodiments, the latch may comprise a pivot point, an upper portion disposed on a first side of the pivot point and defining an upper profile, a lower portion disposed on an opposing side of the pivot point, and a finger pull channel extending into the upper profile for ergonomic application of a rotational force to the upper portion.

In various embodiments, the latch may be rotatable from a retention position in which the latch is configured to retain the tray table in the stowed position and a released position in which the tray table is rotatable to the extended position.

In various embodiments, the latch may be biased toward the retention position.

In various embodiments, in response to the tray table being in the extended position, the latch may be biased toward an unengaged position. In various embodiments, in the unengaged position, the latch may be configured to passively actuate from the unengaged position to the retention position in response to rotation of the tray table into the aircraft monument.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft, in accordance with various embodiments.

FIG. 2 illustrates an aircraft floorplan with a wheelchair plinth, in accordance with various embodiments;

FIG. 3 illustrates a tray table in a stowed position, in accordance with various embodiments;

FIG. 4 illustrates a tray table, in accordance with various embodiments;

FIG. 5 illustrates a tray table in an extended position, in accordance with various embodiments;

FIG. 6 illustrates a latch retaining a tray table, in accordance with various embodiments;

FIG. 7 illustrates a perspective view of a latch in a retention position, in accordance with various embodiments;

FIG. 8 illustrates a rear perspective view of a latch in a retention position, in accordance with various embodiments;

FIG. 9 illustrates a perspective view of a latch in a released position, in accordance with various embodiments;

FIG. 10 illustrates a rear perspective view of latch in a released position, in accordance with various embodiments; and

FIG. 11 illustrates a rear perspective view of latch in an unengaged position, in accordance with various embodiments.

### DETAILED DESCRIPTION

The detailed description of exemplary embodiments herein makes reference to the accompanying drawings, which show exemplary embodiments by way of illustration and its best mode. While these exemplary embodiments are described in sufficient detail to enable those skilled in the art to practice the inventions, it should be understood that other embodiments may be realized and that logical, chemical and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Moreover, many of the functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option.

As aircraft seating technology develops to better provide for and accommodate full-sized wheelchairs, needs arise to adapt and/or build aircraft monuments to be compatible with passenger amenities. Disclosed herein is a pivot mount for a tray table to be installed within and rotatably deploy from a monument to an extended position. Disclosed herein is a latch system for tray table to be retained discreetly within a vertical pocket of the monument when in a stowed position. The tray table may be safely secured within the monument when not in use and rotated from the monument for use as a seat-level or a standing-level tray.

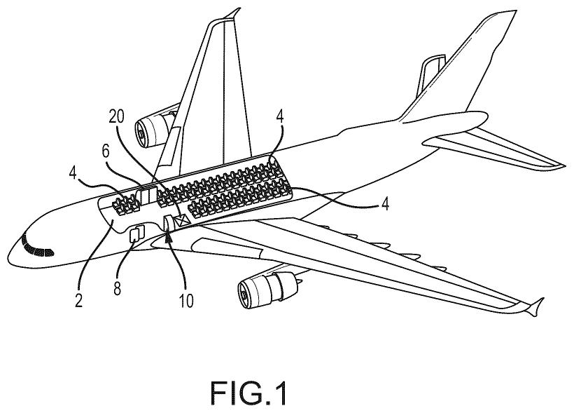

With initial reference to FIG. 1, an aircraft 1 is illustrated, in accordance with various embodiments. Aircraft 1 may comprise an aisle 2. Aircraft 1 may comprise a plurality of seats 4. Aircraft 1 may comprise one or more lavatories 6. Aircraft 1 may comprise a door 8. Aircraft 1 may comprise a monument 10. Aircraft 1 may comprise a wheelchair plinth 20. Wheelchair plinth 20 may be disposed proximate door 8. Wheelchair plinth 20 may be disposed proximate monument 10.

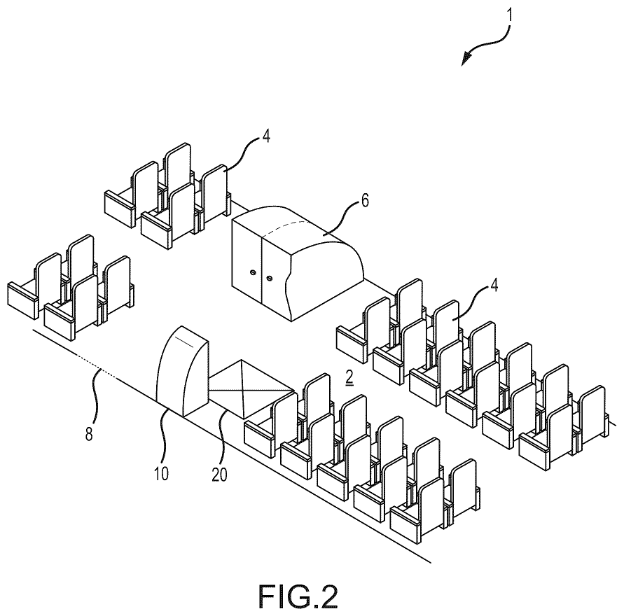

With initial reference to FIG. 2, a floor plan of aircraft 1 is illustrated, in accordance with various embodiments. As illustrated, wheelchair plinth 20 and monument 10 are disposed aft of door 8. However, it should be understood that wheelchair plinth and/or monument 10 may be disposed at any location within aircraft 1. As illustrated, monument 10 is disposed outboard of wheelchair plinth 20 and face inboard toward aisle 2. However, it should be understood that monument 10 may be disposed inboard of wheelchair plinth 20 and face outboard toward wheelchair plinth 20.

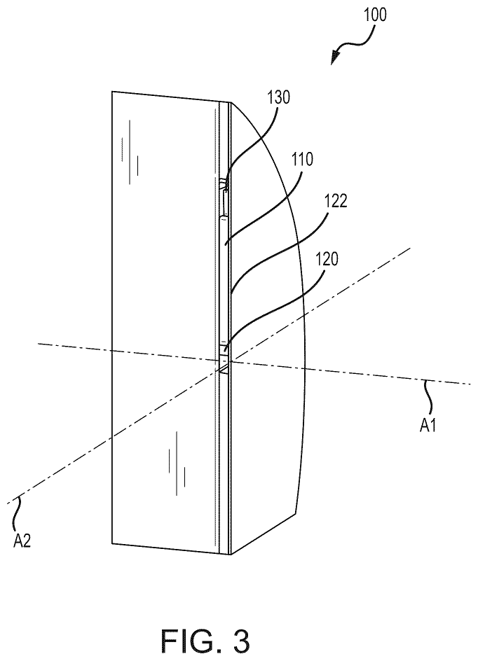

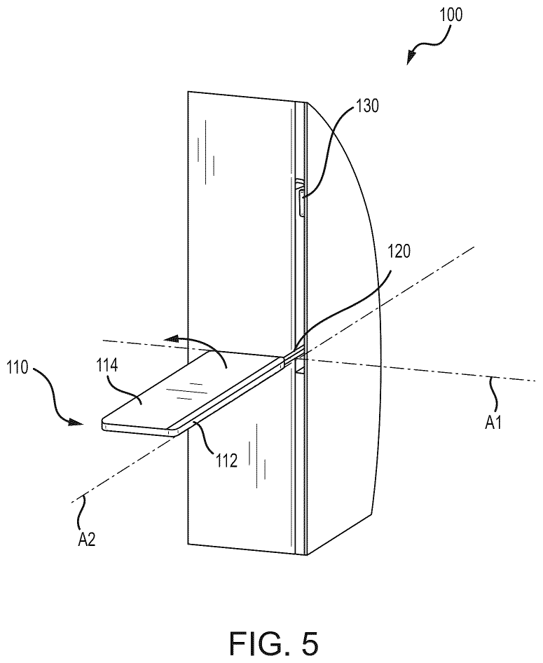

With reference to FIGS. 3-5, a monument 100 is illustrated. Monument 100 may be an aircraft monument similar to monument 10. Monument 100 may comprise a tray table 110. Tray table 110 may be stowable within monument 100. Monument 100 may comprise a latch 130 for retaining the tray table 110 in a stowed position, as illustrated in FIG. 3. Monument 100 may comprise a pivot mount 120 about which tray table 110 may rotate. In various embodiments, tray table 110 may rotate about a first axis A1 defined by the pivot mount 120 to extend from monument 100. In various embodiments, the extendible arm 112 of tray table 110 may rotate about the first axis A1 to extend the rotatable shelf 114 from monument 100. Tray table 110 and/or extendible arm 112 may be free to rotate about the first axis A1 in response to latch 130 being released. As best illustrated in FIGS. 3B and 3C, tray table 110 may comprise a rotatable shelf 114 and an extendible arm 112. Rotatable shelf 114 may be disposed on an end of extendible arm 112. As best illustrated in FIG. 5, rotatable shelf 114 may be rotatable about a second axis A2 to a horizontal position so as to be accessible to aircrew and/or an occupant of wheelchair plinth 20.

As shown in FIG. 3, when the tray table 110 is in the stowed position, the tray table 110 is rotated into the vertical pocket 122. In the stowed position, the tray table 110 may be configured to be discreetly retained within the vertical pocket 122 such that the tray table 110 does not extend beyond a profile of the monument 100. In other words, in the stowed position, the tray table 110 is fully retained within the monument 100. When tray table 110 is in the stowed position, latch 130 is in a retention position, described in further detail below.

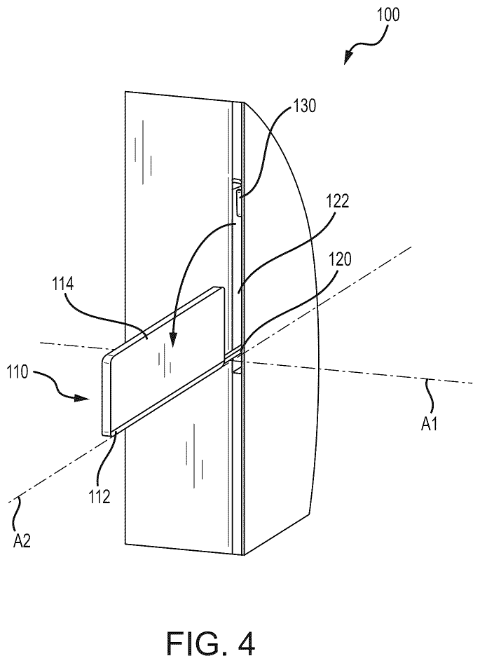

As shown in FIG. 4, tray table 110 is illustrated in a first deployed position. In the first deployed position, the tray table 110 may be rotated from monument 100 until the extendible arm 112 is in a horizontal position. In various embodiments, tray table 110 may be rotated from monument 100 until the extendible arm 112 is in a parallel to the aisle 2 of aircraft 1 (and/or perpendicular to the monument 100). When tray table 110 is being rotated from the stowed position, latch 130 is in a released position, described in further detail below.

As shown in FIG. 5, the tray table 110 is illustrated in a second deployed position in which the extendible arm 112 is in a horizontal position and the rotatable shelf 114 is in a horizontal position. In various embodiments, the extendible arm 112 may extend between discrete positions along the length of the extendible arm 112. In various embodiments, the extendible arm 112 may extend continuously along the length of the extendible arm 112. In this manner, the extendible arm 112 may be adjusted to a position of a passenger seated in the wheelchair plinth 20 (or to a position of an aircrew). When tray table 110 is in an extended position, latch 130 is in an unengaged position, described in further detail below.

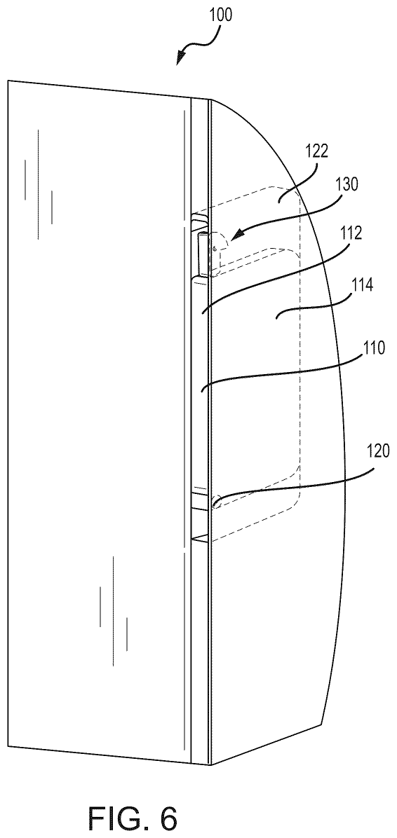

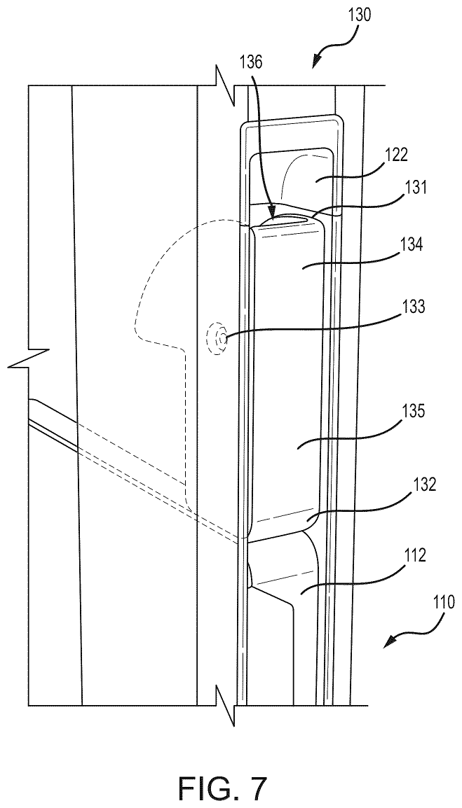

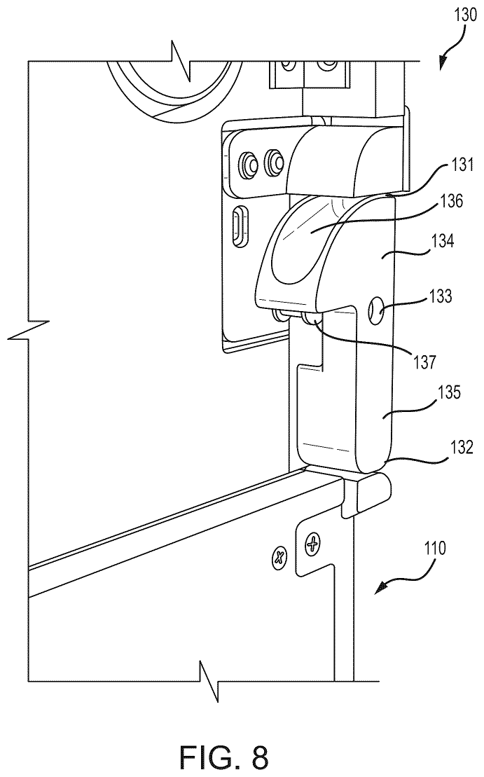

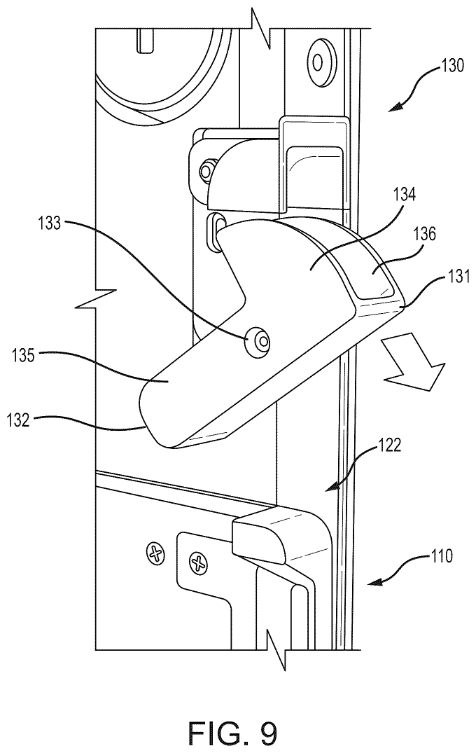

With respect to FIG. 6, tray table 110 is retained in a stowed position within the vertical pocket 122 of monument 100. Latch 130 is in a retention position to retain the tray table 110 in a stowed position. When latch 130 is in the retention position, latch 130 prevents tray table 110 from rotating about the pivot mount 120. Latch 130 may be a passive latch such that the latch 130 must be actuated by a user to release the tray table 110 while the tray table 110 may be stowed by rotating the tray table 110 into latch 130 without independently actuating the latch 130. In other words, latch 130 may be passively receptive to stowage of tray table 110. Latch 130 may be actuated by a user to move latch 130 from a retention position, as shown in FIGS. 6 and 7, to a released position, as shown in FIGS. 8 and 9. Latch 130 may be actuated from the unengaged position to the retention position by passive reception of the tray table 110 into the stowed position. In other words, a user may only need to interact with components of the latch 130 to release, but not to stow, the tray table 110.

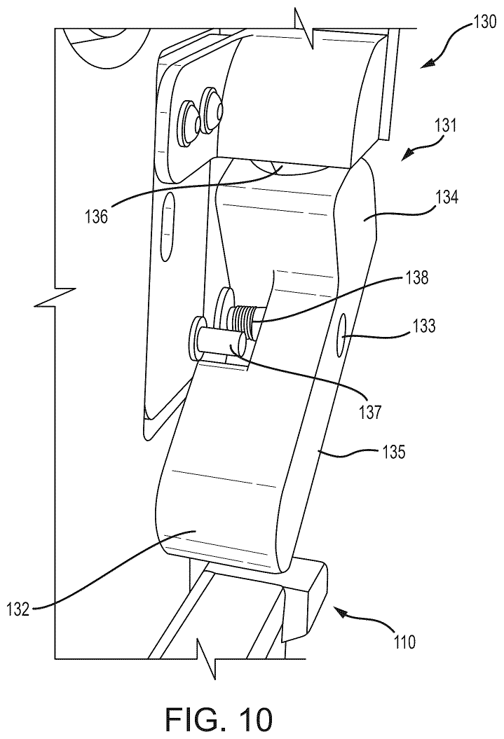

With respect to FIGS. 9 and 10, latch 130 may be rotatable with respect to monument 100 about a pivot point 133. Latch 130 may be a lever with an upper portion 134 disposed on one side of pivot point 133 and a lower portion 135 disposed on an opposing side of pivot point 133. In various embodiments, the pivot point 133 may be a pin rotatably coupling the latch 130 to monument 100.

In various embodiments, the upper portion 134 may define an upper profile 131. Upper profile 131 may be a rounded profile. Accordingly, the rounded profile of upper profile 131 may minimize and/or eliminate pinch points between the latch 130 and the vertical pocket 122. Upper portion 134 may define a finger pull channel 136 extending into the upper profile 131. The finger pull channel 136 may be a rounded channel for ergonomic interaction with the latch 130. In various embodiments, the latch 130 may be rotatable about the pivot point 133 by a force applied to the finger pull channel 136. For example, a user may apply manual force directly to the finger pull channel. However, it should be understood that alternative methods for applying a rotational force to the latch 130 are considered. For example, an external button disposed on an outer wall of monument 100 may be pressed to apply a rotational force to the latch 130.

In various embodiments, the lower portion 135 may define a lower profile 132. The lower portion 135 may be substantially cuboid. The lower portion 135 may define a lower profile 132. The lower profile 132 may be defined by rounded edges such that the lower portion 135 may smoothly rock against tray table 110 as the latch 130 is actuated from the retention position to the released position.

When in the retention position, latch 130 may be discreetly retained within the vertical pocket 122 such that the latch 130 does not extend beyond a profile of the monument 100. In other words, in the stowed position, the latch 130 is fully retained within the monument 100. In various embodiments, the lower portion 135 is disposed in a vertical position when in the retention position.

In various embodiments, and as most clearly shown in FIGS. 8 and 10, latch 130 may comprise a stop 137. The stop 137 may extend from monument 100 into the vertical pocket 122. The stop 137 may be configured to engage the upper portion 134 of the latch 130 so as to prevent over rotation of latch 130. Latch 130 may comprise a spring 138. Spring 138 may bias the upper portion 134 of latch towards the stop 137. In this manner, spring 138 biases the latch 130 toward the retention position. Biasing the latch 130 toward the retention position may ensure retention of the tray table 110 in the stowed position. Biasing the latch 130 toward the retention position may ensure that latch 130 returns to the unengaged position in response to tray table 110 being extended into the extended position. As such, latch 130 can be passively actuated from the unengaged position to the retention position by rotation of tray table 110 to the stowed position without independently applying a force to the latch 130. While described herein as spring loaded, it should be understood that the latch 130 may be biased toward the retention position by other means. For example, the latch 130 may comprise a detent for retaining the latch 130 in the retention position.

With respect to FIG. 9, a rotational force may be applied to latch 130 to rotate the latch 130 from the retention position to a released position. As the lower portion 135 disengages from tray table 110, tray table 110 is free to rotate from the vertical pocket 122. When latch 130 is actuated from the retention position to the released position, upper portion 134 of latch 130 may extend beyond a profile of monument 100 while lower portion 135 may rotate further into the vertical pocket 122.

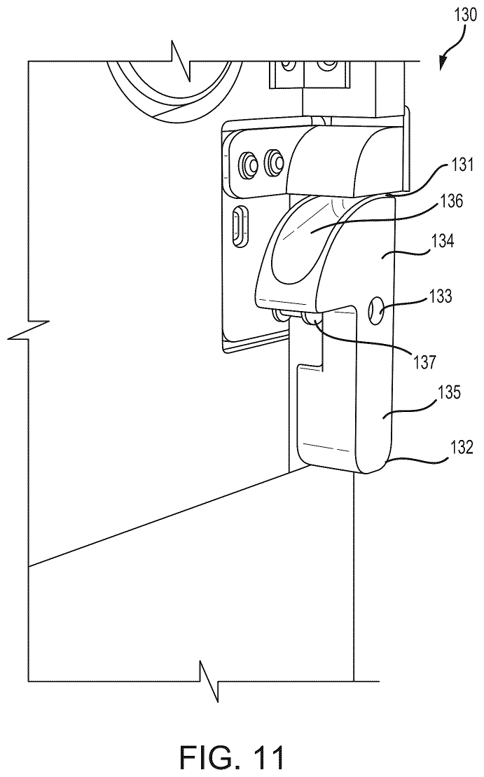

With respect to FIG. 11, latch 130 is illustrated in the unengaged position. In the unengaged position, latch 130 is unengaged from tray table 110. In various embodiments, the tray table 110 may be extended from monument 100 such that vertical pocket 122 is substantially empty. In the unengaged position, spring 138 biases the upper portion 134 of latch 130 toward the stop 137. When in the unengaged position, latch 130 may be discreetly retained within the vertical pocket 122 such that the latch 130 does not extend beyond a profile of the monument 100. In other words, in the stowed position, the latch 130 is fully retained within the monument 100. In various embodiments and as described in detail above, as tray table 110 is rotated into vertical pocket 122, tray table 110 may engage the lower portion 135 of latch 130 to rotate latch 130. As tray table 110 rotates vertical, the tray table 110 will clear the lower portion 135 of latch 130 while spring 138 biases the upper portion 134 of latch 130 toward the stop 137 to place the latch 130 in the retention position.

Finally, it should be noted that while this disclosure is directed primarily to a latch system for a tray table deployed from an aircraft monument, that the concepts described above can also be applied to objects rotatably deployed from alternate structures. For example, latch 130 may be used to retain tray tables within a galley or other aircraft structure. For example, latch 130 may be used to retain other elongate structures within pockets of an aircraft monument or other aircraft structure.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A latch system, comprising:
a pivot point;
an upper portion disposed on a first side of the pivot point and defining an upper profile;
a lower portion disposed on an opposing side of the pivot point; and
a finger pull channel extending into the upper profile for ergonomic application of a rotational force to the upper portion.

2. The latch system of claim 1, further comprising a stop configured to engage the upper portion and to prevent over rotation of the latch system.

3. The latch system of claim 2, further comprising a spring configured to bias the upper portion toward the stop.

4. The latch system of claim 1, wherein the lower portion defines a lower profile having rounded edges.

5. The latch system of claim 1, wherein the lower portion is substantially cuboid.

6. The latch system of claim 3, wherein, when in a retention position, the lower portion is in a vertical position and wherein the latch system is configured to rotate from the retention position to a released position in response to the rotational force being applied to the finger pull channel.

7. An aircraft monument, comprising:
a vertical pocket;
a latch disposed within the vertical pocket, the latch comprising:
a pivot point;
an upper portion disposed on a first side of the pivot point and defining an upper profile;
a lower portion disposed on an opposing side of the pivot point; and
a finger pull channel extending into the upper profile for ergonomic application of a rotational force to the upper portion.

8. The aircraft monument of claim 7, further comprising a pivot mount disposed within the vertical pocket and a tray table configured to be disposed within the vertical pocket in a stowed position and rotate from the vertical pocket about the pivot mount to an extended position, wherein the latch is configured to retain the tray table when in the stowed position.

9. The aircraft monument of claim 8, wherein, in response to being in a retention position, the latch is configured to retain the tray table in the stowed position.

10. The aircraft monument of claim 9, wherein the latch is biased toward the retention position.

11. The aircraft monument of claim 10, wherein the latch further comprises a stop configured to engage the upper portion and to prevent over rotation of the latch.

12. The aircraft monument of claim 9, wherein the latch is configured to rotate from the retention position to a released position in response to application of the rotational force to the latch.

13. The aircraft monument of claim 9, wherein, in response to the tray table being rotated to the extended position, the latch is biased toward an unengaged position.

14. The aircraft monument of claim 13, wherein, in the unengaged position, the latch is fully contained within the vertical pocket.

15. The aircraft monument of claim 13, wherein, in the unengaged position, the latch is configured to actuate from the unengaged position to the retention position in response to rotation of the tray table into the vertical pocket.

16. An aircraft, comprising:
a wheelchair plinth;
an aircraft monument disposed proximate the wheelchair plinth;
a tray table rotatable from a stowed position within the aircraft monument toward the wheelchair plinth to an extended position; and
a latch configured to retain the tray table within the aircraft monument.

17. The aircraft of claim 16, wherein the latch comprises:
a pivot point;
an upper portion disposed on a first side of the pivot point and defining an upper profile;
a lower portion disposed on an opposing side of the pivot point; and
a finger pull channel extending into the upper profile for ergonomic application of a rotational force to the upper portion.

18. The aircraft of claim 16, wherein the latch is rotatable from a retention position in which the latch is configured to retain the tray table in the stowed position and a released position in which the tray table is rotatable to the extended position.

19. The aircraft of claim 18, wherein the latch is biased toward the retention position.

20. The aircraft of claim 18, wherein, in response to the tray table being in the extended position, the latch is biased toward an unengaged position and wherein, in the unengaged position, the latch is configured to passively actuate from the unengaged position to the retention position in response to rotation of the tray table into the aircraft monument.
